(19) United States
(12) Patent Application Publication
(10) Pub. No.: US 2002/0128855 A1
(43) Pub. Date: Sep. 12, 2002

(54) Server and method for providing information relating to requested information

(75) Inventor: Hideto Hidaka, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 09/951,426

(22) Filed: Sep. 14, 2001

(30) Foreign Application Priority Data
Mar. 9, 2001 (JP) 2001-067465

(51) Int. Cl. G06F 17/60

(52) U.S. Cl. 705/1; 705/26

(57) ABSTRACT

An online mediation method includes the steps of, when an article database has been updated, reading the updated article database; reading a user database; searching for users registering keywords of the updated article database as users having degree of association “1” from the user database; searching for the users registering other keywords registered by the users found as the users having degree of association “1”, as users having degree of association “2”; and transmitting information on the buyers found as the users having degrees of association “1” and “2” to sellers registering articles in the article database.

### BACKGROUND OF THE INVENTION

1. Field of the Invention

The present invention relates to an information providing system using a network. The present invention particularly relates to a system for providing information on a buyer relating to an article of commerce to a seller of the article if the article is sold and bought using the network.

2. Description of the Background Art

Following the recent development of the Internet, there appear services for mediating the seller and the buyer of articles of commerce using the Internet. Among them, there is an auction system through the Internet.

According to the auction system, the seller of an article of commerce transmits data representing the article, the lowest bid price and time appointed for accepting in bids to a server. The server allows many buyers to read the transmitted information. The server then holds auction for bids through the Internet. The buyers transmits their bids to the server. After the time appointed for accepting in bids passes, the server gives a person who offered the highest bid (successful bidder) the right to buy the article. If the successful bidder and the seller completed negotiations, the successful bidder buys the article from the seller. A certain ratio of a amount of money to this highest bid price is the profit of the mediator administering the server.

In such auction system, there is a case where keywords are registered for respective articles of commerce and buyers search for the articles using the keywords. This search enables many users to recognize the existence of the articles. In addition, this search enables the server to hold auction among many bidders.

In this auction system, a successful bidder is determined based only on bid prices. The seller of an article often wants to choose a buyer from among many buyers showing interest in the article. In this case, it is necessary to introduce buyers to the seller as requested.

In case of registering keywords, a seller is unaware which keywords were registered for the article of the seller, or which keywords are to be registered for the article which the seller wants to sell. Even if keyword search is available, it is impossible to let many users know the existence of an article of commerce unless the seller of the article registers the keywords for the search.

### SUMMARY OF THE INVENTION

It is an object of the present invention to provide an information providing server and an information providing method capable of providing information relating to information requested by the requester of the information without increasing operations which the requester is required to conduct.

It is another object of the present invention to provide an information providing server and an information providing method capable of providing personal information to the requester of the information.

It is yet another object of the present invention to provide an information providing server and an information providing method capable of providing personal information to the requester of the information based on search items.

It is yet another object of the present invention to provide an information providing server and an information providing method capable of providing personal information to the requester of the information based on search keywords.

It is yet another object of the present invention to provide an information providing server and an information providing method capable of registering appropriate keywords.

It is yet another object of the present invention to provide an information providing server and an information providing method capable of providing personal information based on the request of a person whose personal information is provided to the third parties.

An information providing server according to the present invention is connected to client computers used by users and provides information to the users. The information providing server includes: a communication circuit communicating with the client computers; a first storage circuit, connected to the communication circuit, for receiving and storing first search information from the client computers; a second storage circuit, connected to the communication circuit, for receiving second search information from the client computers and information on the users transmitting the second search information, and for storing the second search information and the information on the users per user. The second search information includes a plurality of search items per user. The information providing server further includes: a search circuit, connected to the first storage circuit and the second storage circuit, for searching for the users storing the second search information having a preset relationship with other second search information including the search items conformed to the first search information; and a transmission circuit, connected to the communication circuit, the second storage circuit and the search circuit, for transmitting information on the users found by the search circuit to the client computers.

The users are searched based on the second search information having a preset relationship with the search items conformed to the first search information. The information providing server can search for not only the users conformed to the first search information transmitted from the buyer but also the users storing the second search information relating to other second search information conformed to the first search information.

In addition, it is preferable that the search circuit includes: a circuit for searching for a first user storing the second search information including the search items conformed to the first search information; a circuit for searching for a plurality of search items stored in correspondence with the first user who is found; and a circuit for searching for a second user storing other second search information including a search item conformed to at least one of the detected plurality of search items.

The search circuit can detect a plurality of search items stored in correspondence with the first user found and search for the second user storing a search item conformed to at least one of the plurality of search items.

Further, it is preferable that the transmission circuit includes a circuit for transmitting the information representing the users found by the search circuit to the client computers transmitting the first search information.

The transmission circuit transmits personal information (e.g., electronic mail addresses) on many users (buyers) to the user (seller) transmitting the first search information.

Furthermore, it is preferable that the information providing server includes: a detection circuit, connected to the second storage circuit, for detecting the number of the stored users per search item; and a user number transmission circuit, connected to the communication circuit and the detection circuit, for transmitting information representing the number of the users per search item and detected by the detection circuit to the client computers transmitting the second search information.

The detection circuit detects the number of stored users per search item. The user number transmission circuit transmits information representing the number of users per search item to the client computers transmitting the second search information. By doing so, the users (buyers) transmitting the second search information can recognize the number of users per search item. If the buyer changes to a seller, this seller can easily register the first search information on an article since this seller grasps the number of users per search item.

Moreover, it is preferable that the information providing server further includes: a determination information storage circuit, connected to the communication circuit, for receiving determination information for determining, from the client computers transmitting the second search information, whether to transmit the information on the users found by the search circuit to the client computers transmitting the first search information, and for storing the determination information per user; and a transmission control circuit, connected to the determination information storage circuit and the transmission circuit, for controlling the transmission circuit to transmit the information on the users found by the search circuit to the client computers transmitting the first search information based on the determination information.

The users (buyers) transmitting the second search information can set determination information for determining whether or not the data of themselves may be transmitted to the user (seller) transmitting the first search information. Thus, if the determination information is set so as not to transmit the data of themselves, the information on the users (buyers) transmitting the second search information is not transmitted to the seller. The users (buyers) can, therefore, avoid receiving unnecessary data (e.g., purchase inquiry from the seller).

Further, it is preferable that the information providing server further includes a calculation circuit for calculating charged amounts of money to be collected from the users transmitting the first search information.

The amount of money collected from the users (sellers) transmitting the first search information can be calculated. Based on the calculated amount, it is possible to carry out a charging processing for charging the users (sellers).

Furthermore, it is preferable that the search information is information represented by a search keyword. The second search information includes a number of search keywords per user. The search circuit includes: a circuit for searching for a first user storing same keywords as the search keywords of the first search information; a circuit for detecting a plurality of search keywords stored in correspondence with the found first users; and a circuit for searching for a second user storing a same search keyword as at least one of the detected plurality of keywords.

The second search information includes a plurality of search keywords per user. The search circuit can search for the users registering the second search information including the same search keywords as those of the first search information, and search for the users registering the second search information including at least one of the plurality of search keywords of the users found. Thus, many users (buyers) can be introduced to sellers based on the search keywords without increasing the operation load of the sellers.

An information providing method according to another aspect of the present invention provides information to users using client computers. The information providing method includes the steps of: receiving and storing first search information from the client computers; receiving second search information from the client computers and information on the users transmitting the second search information; and storing the second search information and the information on the users per user. The second search information includes a plurality of search items per user. The information providing methods further includes the steps of: searching for the users storing the second search information having a preset relationship with other second search information including the search items conformed to the first search information; and transmitting information on the users found in the step of searching for the users, to the client computers.

The users are searched based on the second search information having a preset relationship with the search items conformed to the first search information. The information providing method can search for not only the users conformed to the first search information transmitted from the seller but also the users storing the second search information relating to the other second search information conformed to the first search information.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an overall view showing an online mediation system according to one embodiment of the present invention;

FIG. 2 is an external view of a computer system realizing a server;

FIG. 3 is a control block diagram for the computer system;

FIG. 4 shows an article database stored in a fixed disk;

FIG. 5 shows a user database stored in the fixed disk;

FIG. 6 shows a search result database stored in the fixed disk;

FIG. 7 shows a registrant number database stored in the fixed disk;

FIG. 8 shows article registration request data transmitted from a client computer (seller) to a server;

FIG. 9 shows article registration completion data transmitted from the server to the client computer (seller);

FIG. 10 shows user registration request data transmitted from a client computer (buyer) to the server;

FIG. 11 shows user registration completion data transmitted from the server to the client computer (buyer);

FIG. 12 shows search notification data transmitted from the server to the client computer (seller);

FIG. 13 shows search result request data transmitted from the client computer (seller) to the server;

FIG. 14 shows search result transmission data transmitted from the server to the client computer (seller);

FIG. 15 shows registrant number data transmitted from the server to the client computer (buyer);

FIG. 16 is a flow chart showing an article registration processing carried out by the server;

FIG. 17 is a flow chart showing a registration processing carried out by the server;

FIG. 18 is a flow chart showing a search processing carried out by the server; and

FIG. 19 is a flow chart showing a search result transmission processing carried out by the server.

### DESCRIPTION OF THE PREFERRED EMBODIMENTS

The embodiment of the present invention will be described hereinafter referring to the drawings. In the description and the drawings, the same constituent elements are denoted by the same reference characters and their names and functions are the same, as well. No detailed description will be repeated, therefore, to the constituent elements.

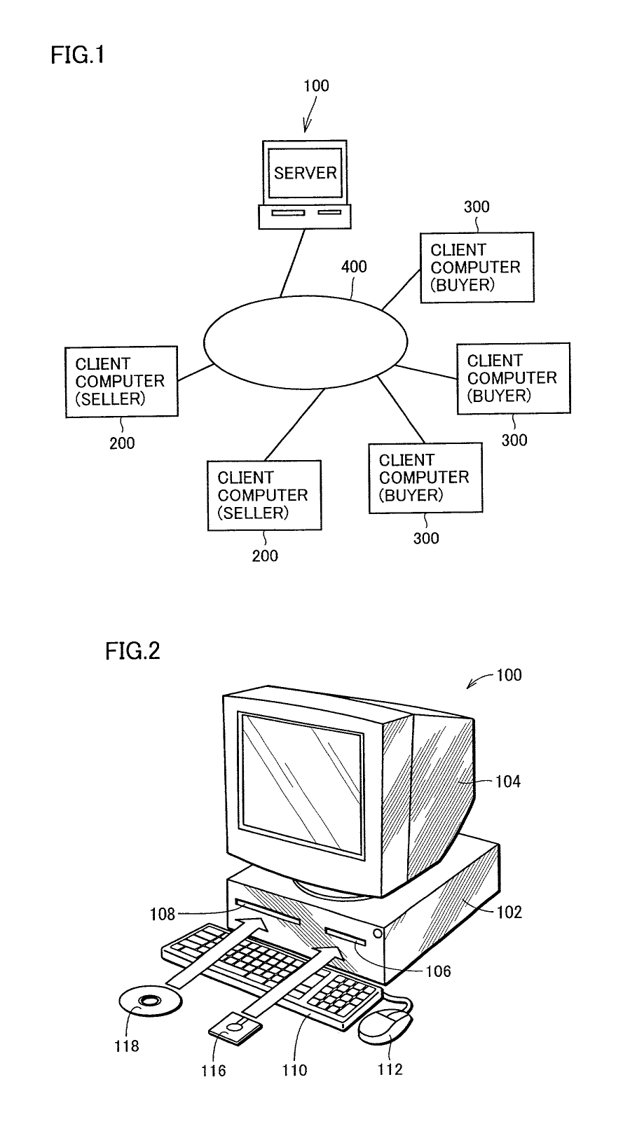

Referring to FIG. 1, an online mediation system according to one embodiment of the present invention includes client computers 200 of the sellers of articles of commerce, client computers 300 of the buyers of the article and a server 100 connected to these client computers 200 and 300 through a network 400.

Server 100 stores articles of commerce which the sellers want to sell and the keywords of the articles in an article database based on article registration request data transmitted from client computers 200 of the sellers. A plurality of keywords are registered per article. The plural keywords are associated with one another. Server 100 responds to the user registration request data transmitted from client computers 300 of the buyers and stores the keywords of the buyers and user information in a user database. The keywords of the buyers are based on the hobby and preferences of the buyers. User information on a plurality of users is stored in the user database. A plurality of keywords per buyer are stored in the user database.

When the article database is updated, server 100 searches for buyers. Server 100 searches for the buyer who registered keywords coincident with the keywords registered for the article updated as buyers having “degree of association 1”. Server 100 detects a plurality of keywords registered by the buyers having “degree of association 1”. Server 100 searches for buyers having at least one keyword out of the detected plural keywords as buyers having “degree of association 2”. Server 100 detects a plurality of keywords registered by the buyers having “degree of association 2”. Server 100 searches for buyers having at least one keyword out of the detected plural keywords as buyers having “degree of association 3”. Server 100 provides information relating to the buyers thus found to the seller.

The information providing function of server 100 in the online mediation system according to this embodiment is realized by allowing the CPU (Central Processing Unit) of the computer to execute a predetermined program.

FIG. 2 is an external view of a computer system as one example of server 100 realizing the information providing function. Referring to FIG. 2, this computer system includes a computer 102 including an FD (Flexible Disk) drive unit 106 and a CD-ROM (Compact Disc-Read Only Memory) drive unit 108, a monitor 104, a keyboard 110 and a mouse 112.

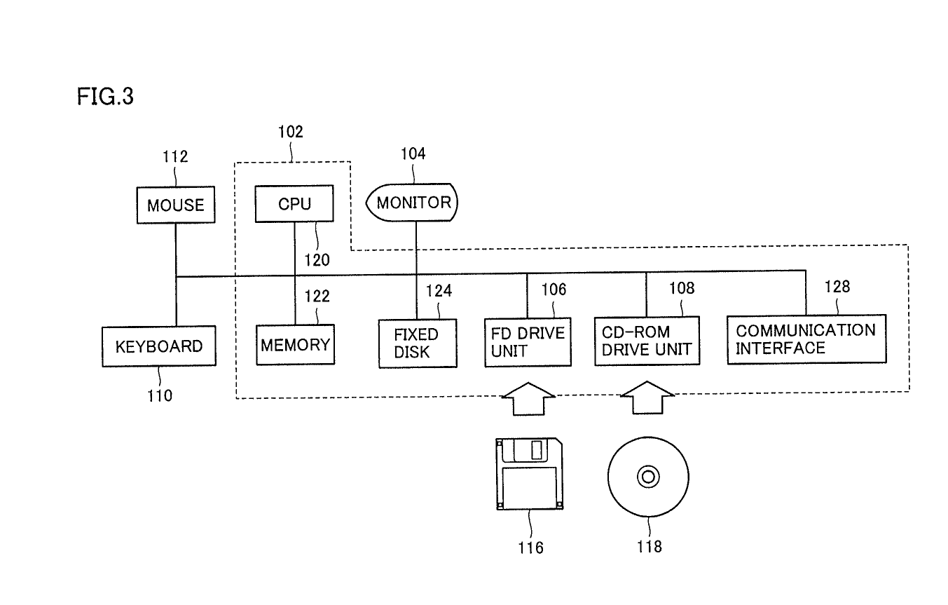

FIG. 3 is a block diagram showing the constitution of the computer system. As shown in FIG. 3, computer 102 includes a CPU (Central Processing Unit) 120, a memory 122, a fixed disk 124 and a communication interface 128 for communicating with other computers in addition to FD drive unit 106 and CD-ROM drive unit 108. FD 116 is set to FD drive unit 106. CD-ROM 118 is set to CD-ROM drive unit 108. Predetermined programs corresponding to software are stored in FD 116 and CD-ROM 118.

As already stated above, server 100 having the information providing function is realized by computer hardware and software executed by CPU 120. The software is normally stored as a program in a recording medium such as FD 116 and CD-ROM 118, distributed, read from the recording medium by FD drive unit 106 or CD-ROM drive unit 108 and temporarily stored in fixed disk 124. Further, the software is read from fixed disk 124 to memory 122 and executed by CPU 120.

The hardware of the computer is an ordinary hardware. The computer includes a control circuit including the CPU, a storage circuit, an input circuit, an output circuit and an OS (Operating System). The computer has an environment for executing the programs. The programs of the present invention allow the computer stated above to realize its information providing function.

Since the operations of the computer itself shown in FIGS. 2 and 3 are well-known, the detailed description will not be repeated herein.

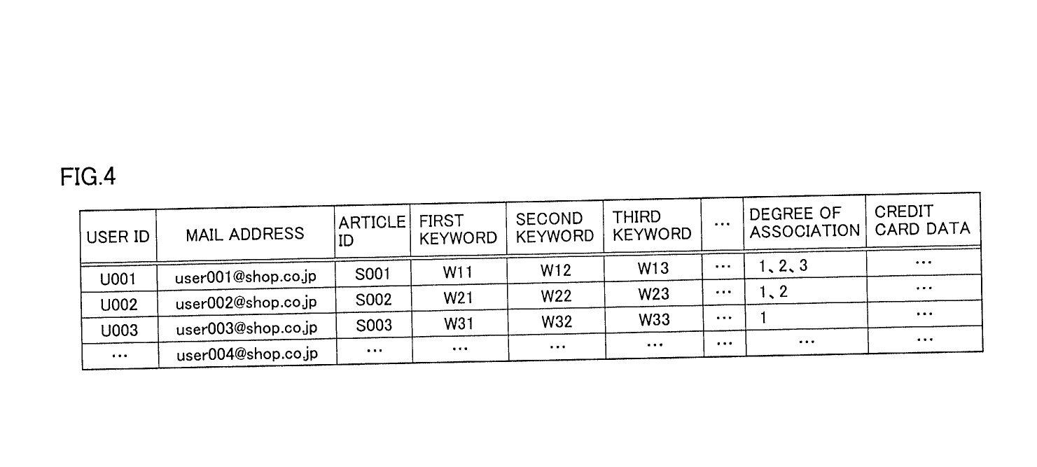

Referring to FIG. 4, an article database stored in fixed disk 124 of server 100 will be described. As shown in FIG. 4, the article database stores the following data per user ID (Identification) for specifying a buyer in this online mediation system. The article database includes the mail address of a seller, an article ID for specifying the article of the seller, first, second and third keywords for the article, degree of association and credit card data. The data registered in the article database is based on the article registration request data transmitted from client computer 200 of the seller. The degree of association is designated by the seller. The degree of association represents a level of association with the article of the seller. If the degree of association is higher, a search is conducted over a range including buyers having lower level of association.

If the degree of association is “1”, the mail addresses of buyers who registered at least one keyword out of the first keyword, the second keyword and the third keyword set for the article are shown to the seller. If the degree of association is “1, 2”, buyers including those who registered other keywords registered by the buyers found as buyers having “degree of association 1” are searched for in addition to the case of the degree of association “1” and the mail addresses of the found buyers are shown to the seller. If the degree of association is “1, 2, 3”, buyers including those who registered other keywords registered by the buyers found as buyers having “degree of association 2” are searched and the mail addresses of the found buyers are shown to the seller.

The credit card data is data for collecting money charged by the seller in compensation for the transmission of the mail addresses of the buyers, from the seller. The charged amount of money collected by this credit card data differs according to the degree of association. The charged amount of money for the seller who designated the degree of association as “1, 2, 3” is larger than that for the seller who designated the degree of association as “1”.

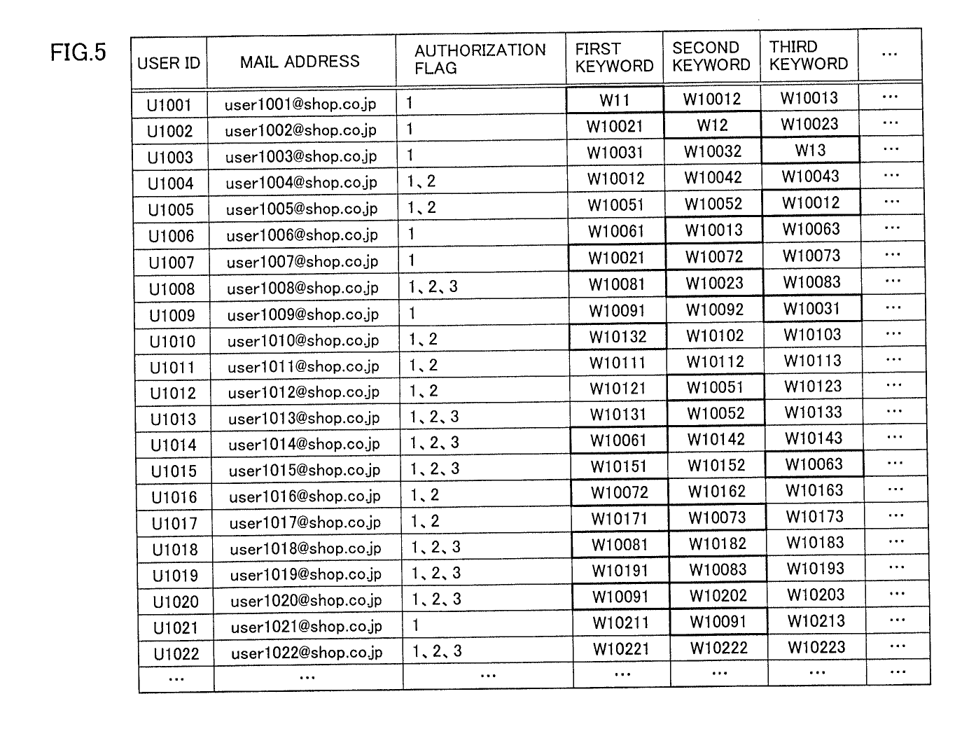

Referring to FIG. 5, a user database stored in fixed disk 124 will be described. As shown in FIG. 5, the user database includes the following data per user ID for specifying a buyer in this online mediation system. The user base includes the mail address of the buyer, an authorization flag, first, second and third keywords per user ID.

The authorization flag is a flag set by the buyer. This authorization flag is set at “1”, “1, 2” or “1, 2, 3”.

A case where a buyer set the authorization flag at “1” will be described. In this case, the authorization flag set at “1” indicates that the buyer authorizes the transmission of the mail address of the buyer to the sellers of articles including the keywords registered by the buyer. A case where a buyer set the authorization flag at “1, 2” will be described. In this case, the authorization flag set at “1, 2” indicates that the buyer authorizes the transmission of the mail address of the buyer if the keywords registered by the buyer are included in a plurality of keywords of the buyers found as buyers having “degree of association 1”. A case where a buyer set the authorization flag at “1, 2, 3” will be described. In this case, the authorization flag set at “1, 2, 3” indicates that the buyer authorizes the transmission of the mail address of the buyer if the keywords registered by the buyer are included in a plurality of keywords of the buyers found as buyers having “degree of association 2”.

As can be seen from the above, if the authorization flag is set at “1” and an article including the keyword itself registered by the buyer is newly registered in the article database, then the mail address of the buyer is transmitted to the seller. If the authorization flag is set at“1, 2” and the other keywords of the buyer who registered the keyword itself of an article newly registered in the article database, then the mail address of the buyer is transmitted to the seller who registered the article. The buyer registers associated keywords in accordance with the buyer's preference, hobby and the like. Many buyers who registered the keywords associated with the article of the seller are shown to the seller.

The authorization flag is registered by each buyer as follows. With the authorization flags set at “1, 2”, the buyers are searched for in a wider range than that with the authorization flags set at “1”. With the authorization flags set at “1, 2, 3”, buyers are searched for in a wider range than that with the authorization flags set at “1, 2”. Due to this, if a buyer wants to avoid becoming search targets for less associated articles from the registered keywords, the authorization flag of the buyer is set at “1” or “1, 2”. By so setting, the buyer is excluded from search targets in case of the authorization flag set at “3” (i.e., search targets for articles less associated with the keywords registered by the buyer). As a result, it is possible to avoid transmitting the mail address of the buyer to the sellers of articles less associated with the keywords registered by the buyer.

Referring to FIGS. 4 and 5, description will be given to a case where an article specified by, for example, an article ID “S001” shown in FIG. 4 is newly registered in the article database. Buyers, who registered any one of the first keyword “W11”, the second keyword “W12” and the third keyword “W13” set by a seller in accordance with the article, are searched for. As shown in FIG. 5, buyers specified by user ID's “U1001”, “U1002” and “U1003”, respectively, are searched for.

The buyer specified by the user ID “U1001” registered, as the second keyword, a keyword “W10012”. As a buyer having “degree of association 2”, a buyer (specified by a user ID “U1005”) who registered the keyword “W10012” is searched for. Further, the buyer (specified by the user ID “U1005”) who registered the keyword “W10012” registered, as the first keyword, a keyword “W10051”. As a buyer having “degree of association 3”, a buyer (specified by a user ID “U1012”) who registered the keyword “W10051” is searched for.

As shown in FIG. 5, if an article specified by an article ID “S001” is newly registered in the article database, buyers specified by user ID's “U1001”, “U1002” and “U1003”, respectively, are searched for as buyers having “degree of association 1”. As buyers having “degree of association 2”, buyers specified by user ID's “U1005”, “U1006”, “U1007”, “U1008”, “U1009” and “U1010”, respectively, are searched for. As buyers having “degree of association 3”, buyers specified by user ID's “U1012”, “U1013”, “U1014”, “U1015”, “U1016” “U1017”, “U1018”, “U1019”, “U1020” and “U 1021”, respectively, are searched for.

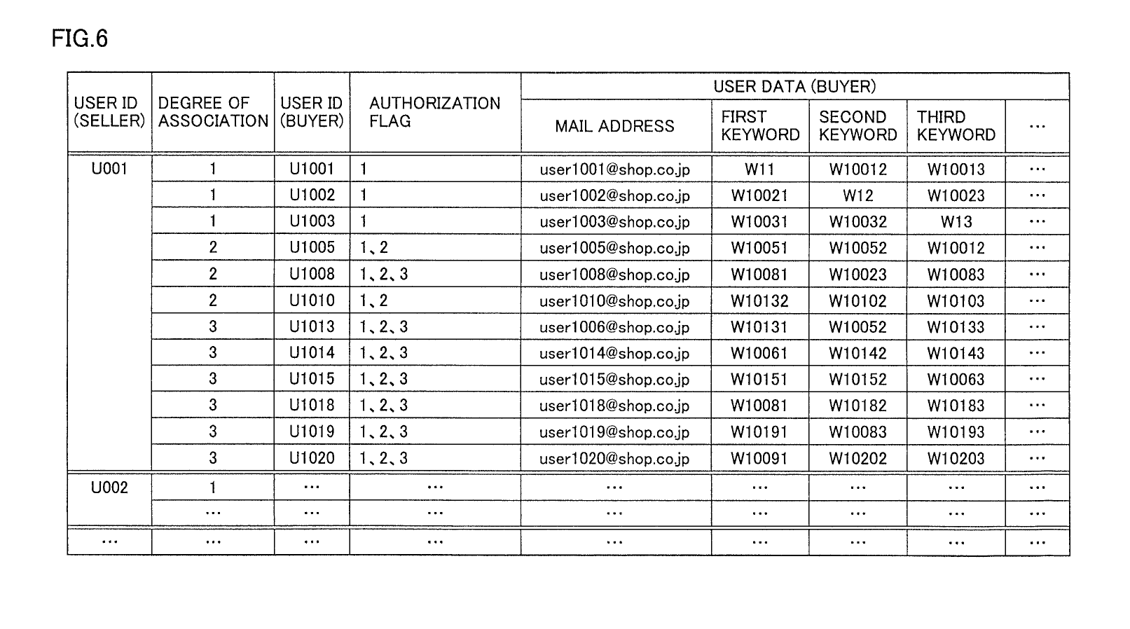

Referring to FIG. 6, a search result database stored in fixed disk 124 will be described. As shown in FIG. 6, the search result database includes the following data per user ID for specifying a seller. The search result database includes the degree of association, the user ID of the buyer as a search result, the authorization flag and user data on the buyer. The user data includes the mail address of the buyer, the first keyword, the second keyword and the third keyword.

User information on the buyer is not registered in the search result database if the degree of association does not satisfy the authorization flag. For example, the buyer, shown in FIG. 5, specified by the user ID “U1021” registered the authorization flag set at “1”. The second keyword “W10091” of the buyer specified by the user ID “U1021” is the first keyword registered by the buyer (specified by the user ID “U1009”) having the first keyword “W10031” of the buyer (specified by the user ID “U1003”) having the third keyword “W13” of the article ID “S001”. In this case, the degree of association of the buyer specified by the user ID “U1021” for the article specified by the article ID “S001” is “3”. The buyer specified by the user ID “U1021” registered an authorization flag set at “1”. Due to this, the degree of association of the buyer specified by the user ID “U1021” does not satisfy the authorization flag of the buyer if the buyer is searched for. As a result, user related information on the buyer specified by the user ID “U1021” is not transmitted to the seller of the article specified by the article ID “S001”.

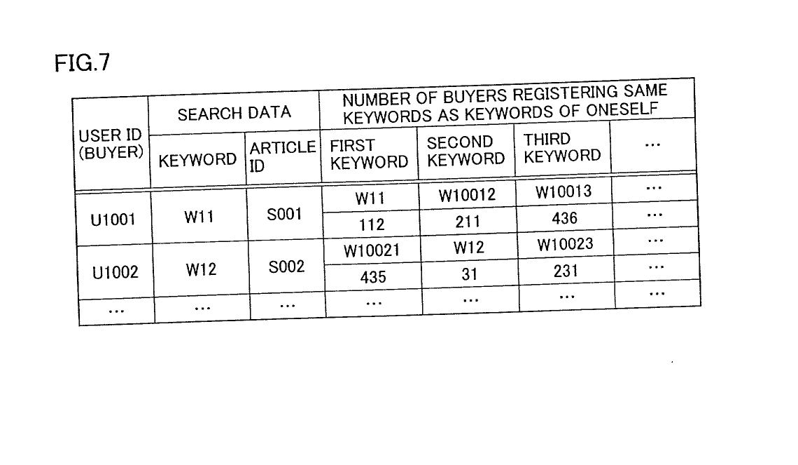

Referring to FIG. 7, a registrant number database stored in fixed disk 124 will be described. As shown in FIG. 7, the registrant number database includes the following data per user ID for specifying a buyer. The registrant number database includes search data and data showing the number of buyers who registered the same keywords as those of a certain buyer. The search data includes a keyword and an article ID. The data showing the number of buyers registering the same keywords as those of the buyer oneself includes the first keyword, data showing the number of buyers registering the first keyword, the second keyword, data showing the number of buyers registering the second keyword, the third keyword and data showing the number of buyers registering the third keyword.

For example, the first keyword of the buyer specified by the user ID “U1001” is coincident with the first keyword “W11” of the article specified by the article ID “S001”. The buyer specified by the user ID “U1001” is, therefore, searched for as a buyer having “degree of association 1” for the article specified by the article ID “S001”. The mail address of the buyer specified by the user ID “U1001” is transmitted to the seller. The number of other buyers registering the keyword registered by the buyer (specified by the user ID “U1001”) whose mail address has been transmitted, is transmitted to the buyer (specified by the user ID “U1001”). Thus, the buyers can grasp how many buyers exist for which keywords in this online mediation system. If a buyer changes to a seller, this seller can set keywords for the article of the seller based on this information.

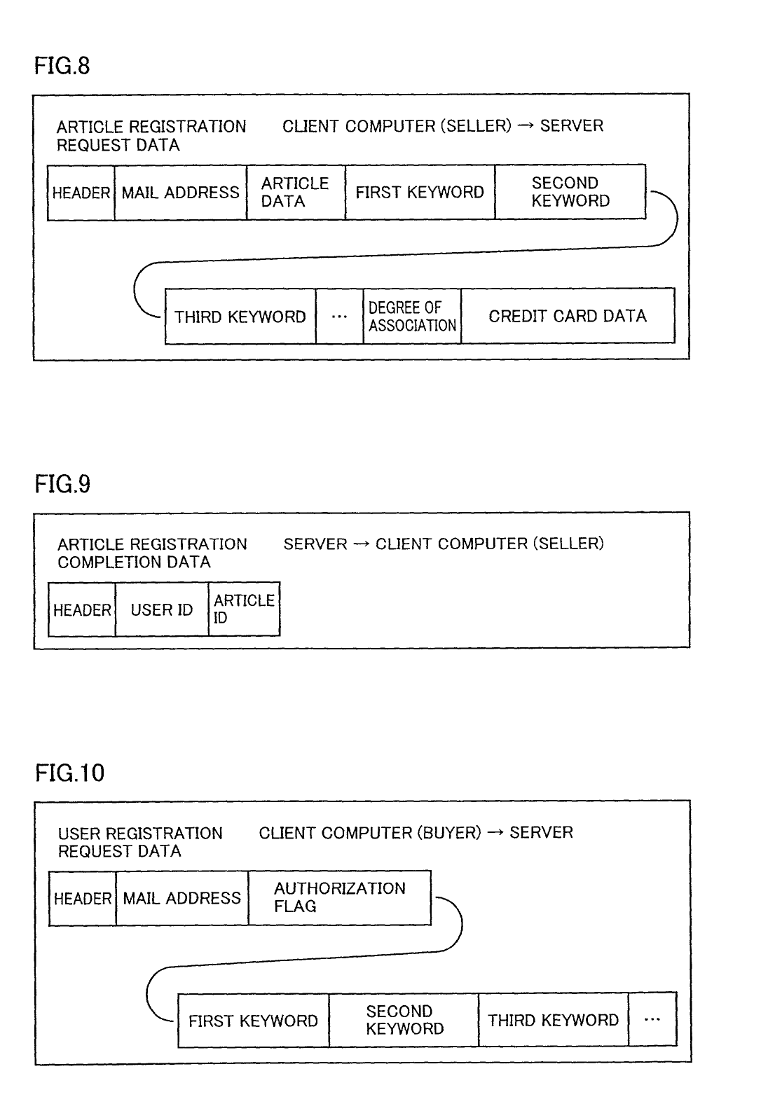

Referring to FIG. 8, description will be given to article registration request data transmitted from client computer 200 of the seller to server 100. As shown in FIG. 8, the article registration request data includes a header, a mail address, article data, the first keyword, the second keyword, the third keyword, degree of association and credit card data. The mail address shown in FIG. 8 is that of the seller.

Referring to FIG. 9, description will be given to article registration completion data transmitted from server 100 to client computer 200 of the seller. As shown in FIG. 9, the article registration completion data includes a header, a user ID and an article ID. The user ID and the article ID are identification codes allotted by server 100 so as to specify a seller and an article in this online mediation system, respectively.

Referring to FIG. 10, description will be given to user registration request data transmitted from client computer 300 of the buyer to server 100. As shown in FIG. 10, the user registration request data includes a header, a mail address, an authorization flag, the first keyword, the second keyword and the third keyword. The mail address shown in FIG. 10 is that of the buyer.

Referring to FIG. 11, description will be given to user registration completion data transmitted from server 100 to client computer 300 of the buyer. As shown in FIG. 11, the user registration completion data includes a header and a user ID. The user ID shown in FIG. 11 is an identification code allotted by server 100 so as to specify a registered buyer in this online mediation system.

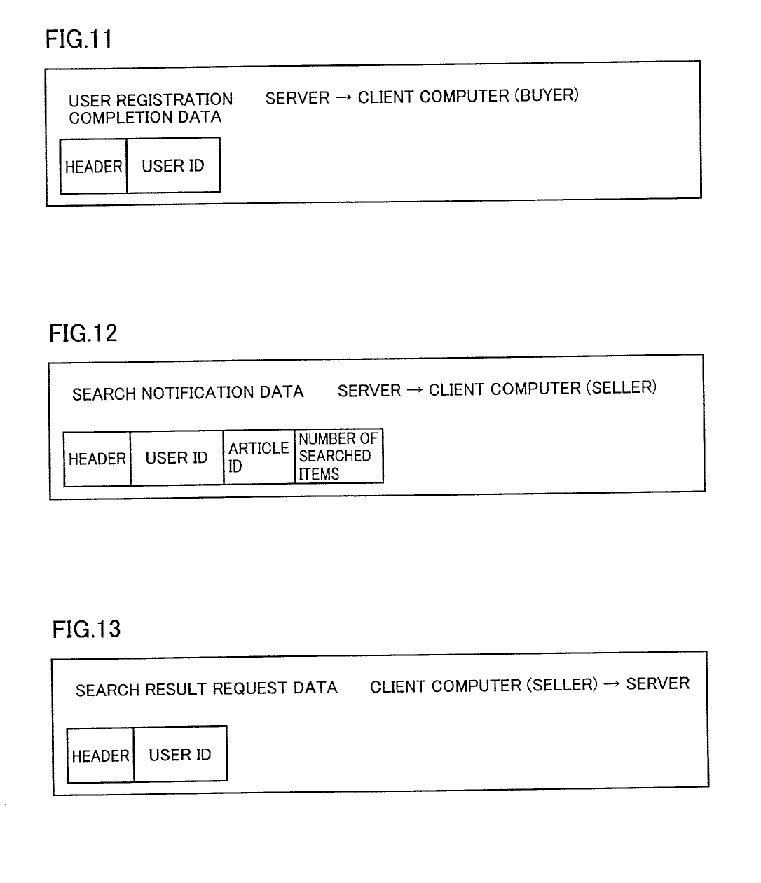

Referring to FIG. 12, description will be given to search notification data transmitted from server 100 to client computer 200 of the seller. As shown in FIG. 12, the search notification data includes a header, a user ID, an article ID and the number of searched items. The number of searched items is the number of items found per article ID and calculated based on the search result database shown in FIG. 6.

Referring to FIG. 13, description will be given to search result request data transmitted from client computer 200 of the seller to server 100. As shown in FIG. 13, the search result request data includes a header and a user ID. The user ID shown in FIG. 13 is a user ID for specifying a seller. The search result request data is data for allowing the seller receiving the search notification data shown in FIG. 12 to request server 100 to transmit more detailed information to the seller.

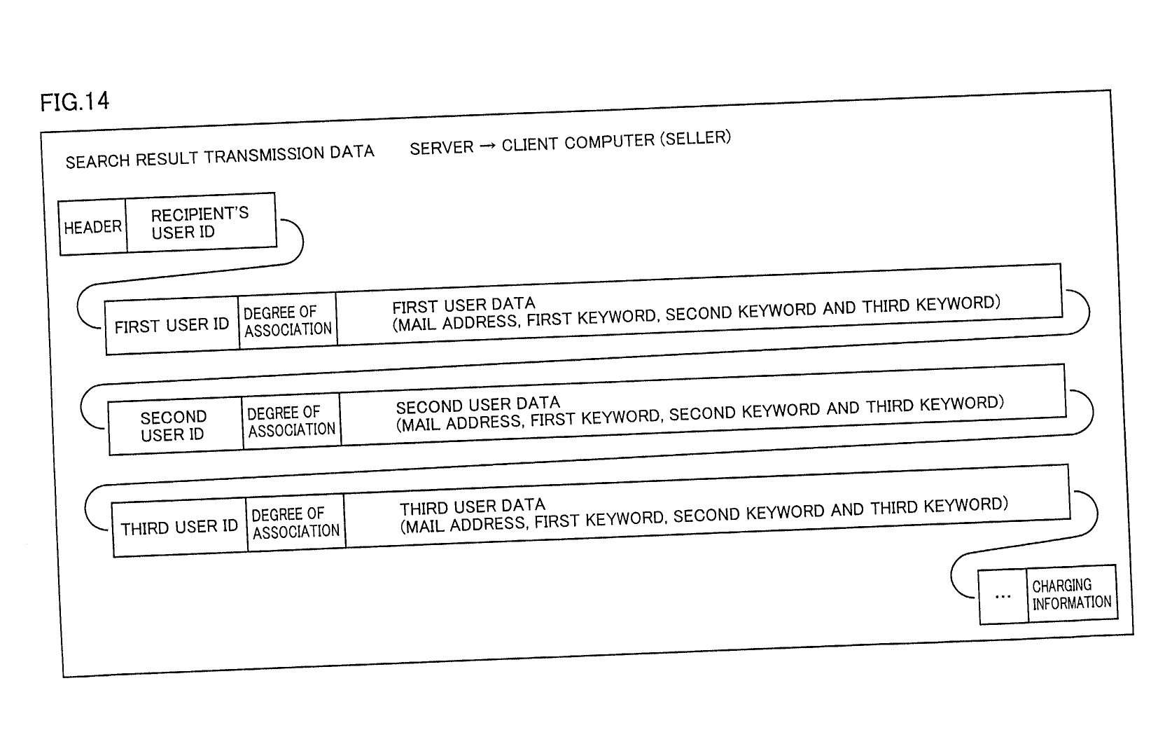

Referring to FIG. 14, description will be given to search result transmission data transmitted from server 100 to client computer 200 of the seller. As shown in FIG. 14, the search result transmission data includes a header, the user ID of the recipient (seller), the first user ID, degree of association, the first user data, the second user ID, degree of association, the second user data, the third user ID, degree of association, the third user data and charging information. The user data includes a mail address, the first keyword, the second keyword and the third keyword. The search result transmission data shown in FIG. 14 is transmitted from the server 100 responding to the search result request data shown in FIG. 13 to client computer 200 of the seller.

Referring to FIG. 15, description will be given to registrant number notification data transmitted from server 100 to client computer 300 of the buyer. As shown in FIG. 15, the registrant number notification data includes a header, the user ID of the recipient (buyer), keywords, an article ID, the first keyword, the first keyword registrant number, the second keyword, the second keyword registrant number, the third keyword and the third keyword registrant number. The registrant number notification data shown in FIG. 15 is created based on the data registered in the registrant number database shown in FIG. 7.

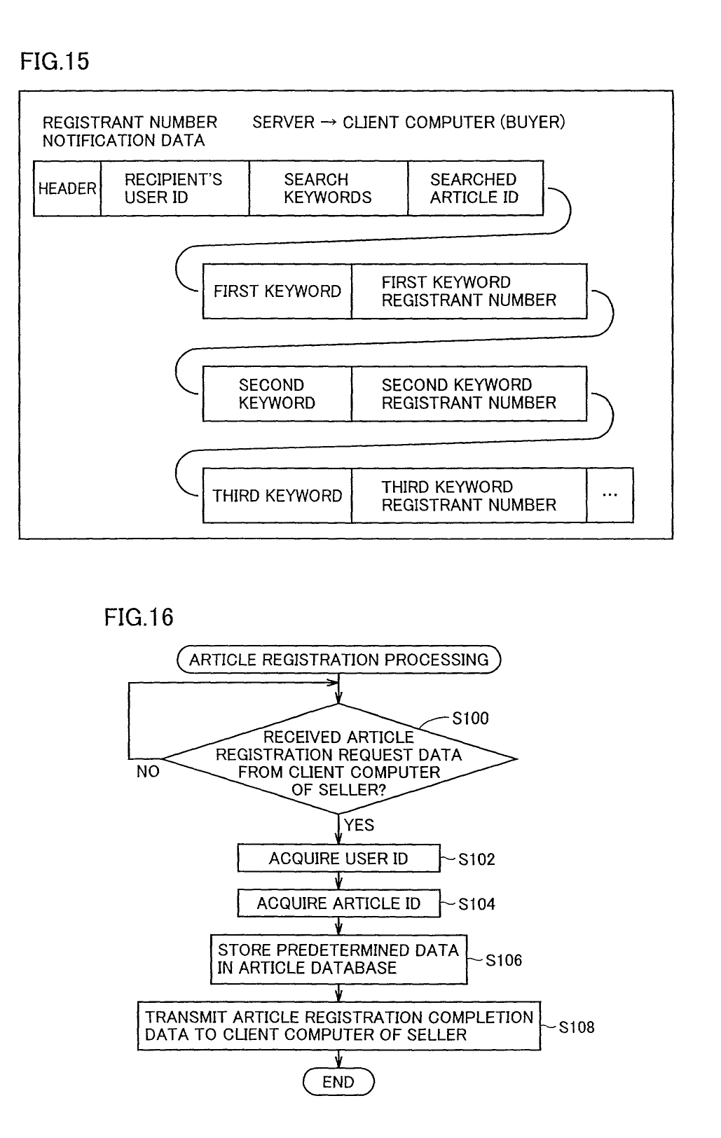

Referring to FIG. 16, the program executed by server 100 has the following control structure with respect to an article registration processing.

In a step (to be referred to as “S” in short hereinafter) 100, CPU 120 determines whether or not server 100 received the article registration request data shown in FIG. 8 from client computer 200 of the seller. If receiving the article registration request data from client computer 200 of the seller (“YES” in S100), the processing moves to S102. If not (“NO” in S100), the processing returns to S100 and server 100 waits to receive the article registration request data from client computer 200 of the seller.

In S102, CPU 120 acquires a user ID for specifying the seller in this online mediation system. In S104, CPU 120 acquires an article ID for specifying an article to be handled in this online mediation system.

In S106, CPU 120 stores predetermined data including the user ID and the article ID acquired in S 102 and S 104, in the article database shown in FIG. 4. In S108, CPU 120 transmits the article registration completion data shown in FIG. 9 to client computer 200 of the seller. The seller who received the article registration completion data is informed that the user ID and the article ID have been registered in the article database.

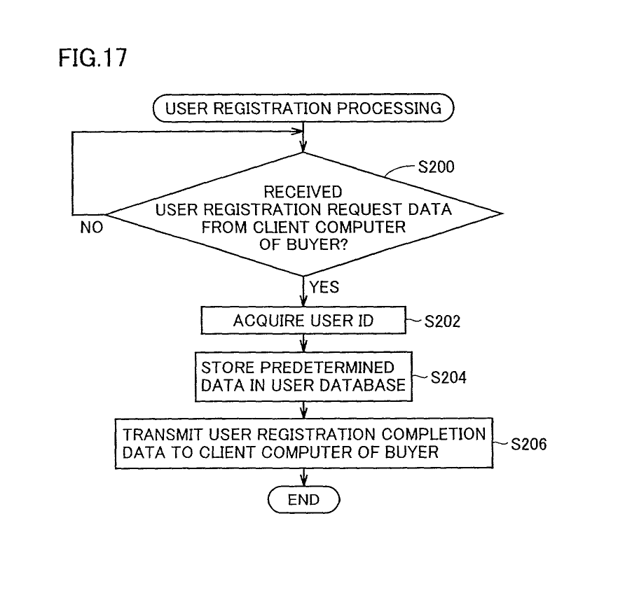

Referring to FIG. 17, the program executed by server 100 has the following control structure with respect to a user registration processing.

In S200, CPU 120 determines whether or not server 100 received the user registration request data shown in FIG. 10 from client computer 300 of the buyer. If receiving the user registration request data from client computer 300 of the buyer (“YES” in S200), the processing returns to S202. If not (“NO” in S200), the processing moves to S200 and server 100 waits to receive the user registration request data from client computer 300 of the buyer.

In S202, CPU 120 acquires a user ID for specifying the buyer in this online mediation system. In S204, CPU 120 stores the data including the user ID acquired in S202, in the user database shown in FIG. 5.

In S206, CPU 120 transmits the user registration completion data shown in FIG. 11 to client computer 300 of the buyer. The buyer receiving the user registration completion data is informed that the user ID has been registered in the user database.

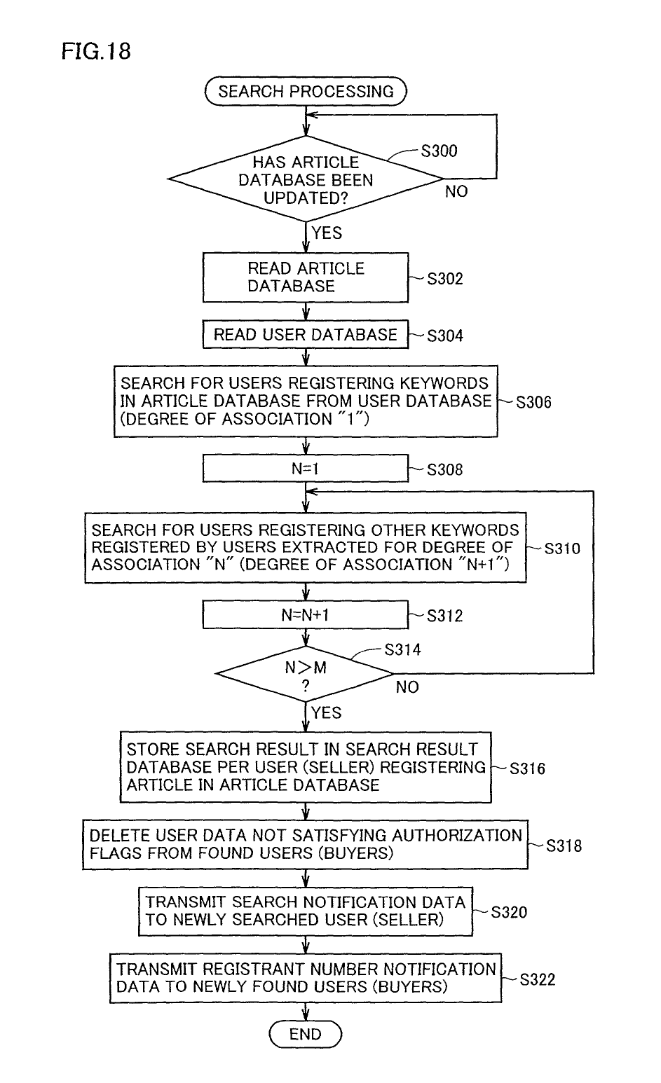

Referring to FIG. 18, the program executed by server 100 has the following control structure with respect to a search processing.

In S300, CPU 120 determines whether or not the article database shown in FIG. 4 has been updated. The article database is updated when the processing in S 106 shown in FIG. 16 has been executed. Namely, the article database is updated when server 100 has received new article registration request data from client computer 200 of the seller. If the article database has been updated (“YES” in S300), the processing moves to S302. If not (“NO” in S300), the processing returns to S300 and the server 100 waits for the article database to be updated.

In S302, CPU 120 reads the updated data from the article database. In S304, CPU 120 reads the user database shown in FIG. 5.

In S306, CPU 120 searches for buyers who registered the keywords of the updated article from the user database shown in FIG. 5. The buyers found at this moment are buyers having “degree of association 1”.

In S308, CPU 120 initializes a variable N (N=1). In S310, CPU 120 searches for buyers who registered other keywords registered by the buyers found as buyers having “degree of association N”. The buyers found at this moment are buyers having “degree of association (N+1)”.

In S312, CPU 120 adds 1 to the variable N. In S314, CPU 120 determines whether or not the variable N is higher than a preset constant M. The preset constant M shows a maximum value of the degree of association in this online mediation system. If the variable N is higher than the constant M (“YES” in S314), the processing moves to S316. If not (“NO” in S314), the processing returns to S310 and buyers having the next degree of association are searched for.

In S316, CPU 120 stores a search result in the search result database (FIG. 6) per user (seller) found using the keywords of the updated article. In S318, CPU 120 deletes data on users having the degrees of association which do not satisfy the authorization flags from the users (buyers) stored in S316.

In S320, CPU 120 transmits search notification data shown in FIG. 12 to the newly found user (seller).

In S322, CPU 120 transmits registrant number notification data shown in FIG. 15 to newly found users (buyers).

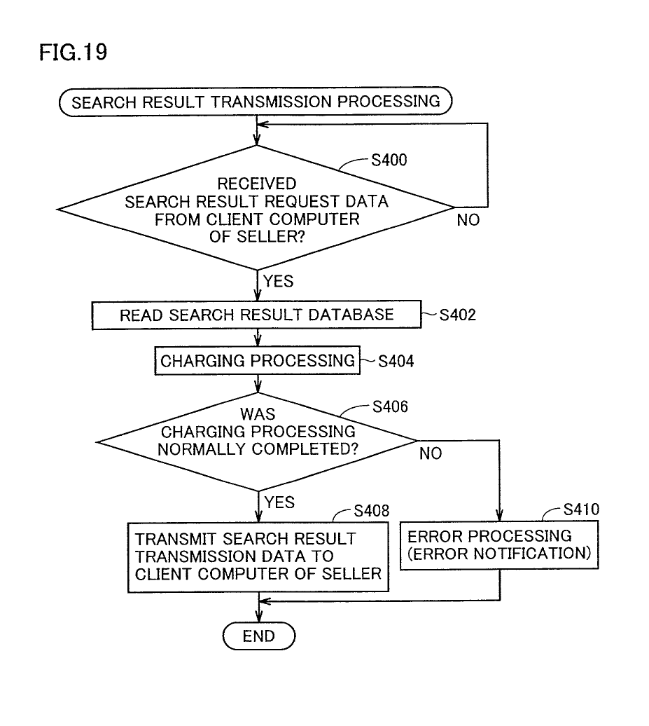

Referring to FIG. 19, the program executed by server 100 has the following control structure with respect to a search result transmission processing.

In S400, CPU 120 determines whether or not server 100 received the search result request data shown in FIG. 13 from client computer 200 of the seller. If server 100 received the search result request data shown in FIG. 13 from client computer 200 of the seller (“YES” in S400), the processing moves to S402. If not (“NO” in S400), the processing returns to S400 and server 100 waits to receive the search result request data from client computer 200 of the seller.

In S402, CPU 120 reads the search result database shown in FIG. 6. In S404, CPU 120 carries out a charging processing using the credit card data stored in the article database. In S406, CPU 120 determines whether or not the charging processing was normally completed in S404. If the charging processing was normally completed (“YES” in S406), the processing moves to S408. If not (“NO” in S406), the processing moves to S410.

In S408, CPU 120 transmits the search result transmission data shown in FIG. 14 to client computer 200 of the seller. In S410, CPU 120 carries out an error processing (error notification).

The seller receiving the search result transmission data shown in FIG. 14 receives the mail addresses of the buyers registering keywords associated with the keywords of the article to be sold. Base on the mail addresses, the seller contacts with the buyers and negotiates with the buyers about the selling and buying of the article.

Now, the operations of server 100 in the online mediation system based on the structures and flow charts stated above will be described.

### Article Registration Operation

When the seller transmits the article registration request data including the items shown in FIG. 8 using client computer 200, server 100 receives the data (“YES” in S100). Server 100 acquires the user ID and the article ID (in S 102 and S 104) and the user ID and the article ID are stored in the article database shown in FIG. 4 (in S106).

When the data has been stored in the article database, the article registration completion data shown in FIG. 9 is transmitted to client computer 200 of the seller. The seller receiving the article registration completion data is informed that the article of the seller has been registered. Through these operations, the article registration operation of the seller is completed.

### User Registration Operation

When the buyer transmits the user registration request data shown in FIG. 10 to server 100 using client computer 300, server 100 receives the data (“YES” in S200). Server 100 acquires the user ID (in S202) and the data is stored in the user database shown in FIG. 5 (in S204). When the data has been stored in the user database, the user registration completion data shown in FIG. 11 is transmitted to client computer 300 of the buyer. The buyer receiving the user registration completion data is informed that he or she has been registered in the user database.

### Search Operation

When the seller carries out an article registration request operation to server 100 using client computer 200, the article database shown in FIG. 4 is updated (“YES” in S300). The updated article database is read (in S302) and the user database shown in FIG. 5 is read (in S304). Buyers registering the keywords of the article updated are searched for as buyers having “degree of association 1” from the user database (in S306). Buyers registering other keywords registered by the buyers having “degree of association 1” are searched for as buyers having “degree of association 2” (in S310). If a search is continued further (“NO” in S314), buyers having “degree of association 3” are searched for.

The search result data is stored in the search result database shown in FIG. 6 per seller registering an article in the article database (in S316).

Data on users, among the users (buyers) stored, having degrees of association which do not satisfy the authorization flags is deleted from the data stored in the search result database (in S318).

The search notification data shown in FIG. 12 is transmitted to a newly found user (seller) (in S320). The registrant number notification data shown in FIG. 15 is transmitted to newly found users (buyers) (in S322).

Through these operations, the seller newly registering an article is notified of the number of buyers having degrees of associations which satisfy the authorization flags by the search notification data. Thus, the seller can be informed of the number of buyers registering keywords associated with the keywords of the article which the seller wants to sell. The registrant number notification data showing the number of buyers registering the keywords which each user (buyer) oneself registered is transmitted to the user (buyer) found as the buyer registering the keywords associated with the keywords of the newly registered article. The mail addresses of the buyers are notified to the seller. The buyer is informed of the number of buyers registering the same keywords as those registered by the buyer. When a buyer changes to a seller, keywords are registered for an article. The keywords registered by many buyers can be registered in this online mediation system.

### Search Result Transmission Operation

The seller receiving the search notification data shown in FIG. 12 requests the search result based on the number of searched items, the search result request data shown in FIG. 13 is transmitted from client computer 200 of the seller to server 100. Server 100 receives the search result request data (“YES” in S400) and reads the search result database shown in FIG. 6 (in S402). Server 100 carries out a charging processing (in S404). When the charging processing has been normally completed (“YES” in S406), the search result transmission data shown in FIG. 14 is transmitted to client computer 200 of the seller.

The seller receiving the search result transmission data can be informed of the mail addresses of the buyers registering the keywords associated with the keywords of the article which the seller wants to sell. At this moment, the seller is notified of the mail addresses of (or data on) not only the buyers who registered the keywords of the article but also the buyers who registered other keywords registered by the buyers registering the keywords of the article.

As stated so far, the server in the online mediation system according to this embodiment receives and stores the article ID and the keywords for the article from the seller of the article. The server receives and stores the mail addresses of buyers and a plurality of keywords registered by the buyers from the buyers. When the seller newly registers an article, the article database is updated. Buyers who registered the keywords registered for the article are searched for as buyers having “degree of association 1”. Other buyers who registered other keywords registered by the buyers having “degree of association 1” are searched for as buyers having “degree of association 2”. In this way, it is possible to provide a server in the online mediation system capable of introducing many buyers registering keywords associated with keywords registered for the article of a seller without increasing the operation load of the seller.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An information providing server, connected to client computers used by users, for providing information to said users, comprising:
a communication circuit communicating with said client computers;
a first storage circuit, connected to said communication circuit, for receiving and storing first search information from said client computers;
a second storage circuit, connected to said communication circuit, for receiving second search information from said client computers and information on the users transmitting said second search information, and for storing said second search information and said information on the users per user, said second search information including a plurality of search items per user, wherein
said information providing server further comprises:
a search circuit, connected to said first storage circuit and said second storage circuit, for searching for the users storing the second search information having a preset relationship with the other second search information including the search items conformed to said first search information; and
a transmission circuit, connected to said communication circuit, said second storage circuit and said search circuit, for transmitting information on the users found by said search circuit to said client computers.

2. The information providing server according to claim 1, wherein
said search circuit comprises:
a circuit for searching a first user storing the second search information including the search items conformed to said first search information;
a circuit for searching for a plurality of search items stored in correspondence with said first user found; and
a circuit for searching for a second user storing the other second search information including a search item conformed to at least one of said detected plurality of search items.

3. The information providing server according to claim 1, wherein
said transmission circuit includes a circuit for transmitting the information representing the users found by said search circuit to the client computers transmitting said first search information.

4. The information providing server according to claim 1, further comprising:
a detection circuit, connected to said second storage circuit, for detecting the number of the stored users per search item; and
a user number transmission circuit, connected to said communication circuit and said detection circuit, for transmitting information representing the number of the users per search item and detected by said detection circuit to the client computers transmitting said second search information.

5. The information providing server according to claim 1, further comprising:
a determination information storage circuit, connected to said communication circuit, for receiving determination information for determining, from the client computers transmitting said second search information, whether to transmit the information on the users found by said search circuit to the client computers transmitting said first search information, and for storing the determination information per said user; and
a transmission control circuit, connected to said determination information storage circuit and said transmission circuit, for controlling said transmission circuit to transmit the information on the users found by said search circuit to the client computers transmitting said first search information based on said determination information.

6. The information providing server according to claim 1, further comprising:
a calculation circuit for calculating charged amounts of money to be collected from the users transmitting said first search information.

7. The information providing server according to claim 1, wherein
said search information is information represented by a search keyword;
said second search information includes a plurality of search keywords per said user;
said search circuit includes:
a circuit for searching for a first user storing same keywords as the search keywords of said first search information;
a circuit for detecting a plurality of search keywords stored in correspondence with said first users found; and
a circuit for searching for a second user storing a same search keyword as at least one of said detected plurality of keywords.

8. An information providing server, connected to client computers used by users, for providing information to said users, comprising:
communication means for communicating with said client computers;
first storage means, connected to said communication means, for receiving and storing first search information from said client computers;
second storage means, connected to said communication means, for receiving second search information from said client computers and information on the users transmitting said second search information, and for storing said second search information and said information on the users per said user, said second search information including a plurality of search items per said user, wherein
said information providing server further comprises:
search means, connected to said first storage means and said second storage means, for searching for the users storing the second search information having a preset relationship with the other second search information including the search items conformed to said first search information; and
transmission means, connected to said communication means, said second storage means and said search means, for transmitting information on the users found by said search means to said client computers.

9. The information providing server according to claim 8, wherein
said search means comprises:
means for searching for a first user storing the second search information including the search items conformed to said first search information;
means for searching for a plurality of search items stored in correspondence with said first user found; and
means for searching for a second user storing the other second search information including a search item conformed to at least one of said detected plurality of search items.

10. The information providing server according to claim 8, wherein
said transmission means includes means for transmitting the information representing the users found by said search means to the client computers transmitting said first search information.

11. The information providing server according to claim 8, further comprising:
detection means, connected to said second storage means, for detecting the number of the stored users per said search item; and
user number transmission means, connected to said communication means and said detection means, for transmitting information representing the number of the users per said search item and detected by said detection means to the client computers transmitting said second search information.

12. The information providing server according to claim 8, further comprising:
determination information storage means, connected to said communication means, for receiving determination information for determining, from the client computers transmitting said second search information, whether to transmit the information on the users found by said search means to the client computers transmitting said first search information, and for storing the determination information per said user; and
transmission control means, connected to said determination information storage means and said transmission means, for controlling said transmission means to transmit the information on the users found by said search means to the client computers transmitting said first search information based on said determination information.

13. The information providing server according to claim 8, further comprising:
calculation means for calculating charged amounts of money to be collected from the users transmitting said first search information.

14. The information providing server according to claim 8, wherein
said search information is information represented by a search keyword;
said second search information includes a plurality of search keywords per said user;
said search means includes:
means for searching for a first user storing same search keywords as the search keywords of said first search information;
means for detecting a plurality of search keywords stored in correspondence with said first users found; and
means for searching a second user storing a same search keyword as at least one of said detected plurality of keywords.

15. An information providing method for providing information to users using client computers, comprising the steps of:
receiving and storing first search information from said client computers;
receiving second search information from said client computers and information on the users transmitting said second search information, and storing said second search information and said information on the users per said user, said second search information including a plurality of search items per user, wherein
said information providing methods further comprises the steps of:
searching for the users storing the second search information having a preset relationship with the other second search information including the search items conformed to said first search information; and
transmitting information on the users found in the step of searching for said users, to said client computers.

16. The information providing method according to claim 15, wherein
the step of searching for said users comprises the steps of:
searching for a first user storing the second search information including the search items conformed to said first search information;
detecting a plurality of search items stored in correspondence with said first user found; and
searching for a second user storing the other second search information including a search item conformed to at least one of said detected plurality of search items.

17. The information providing method according to claim 15, wherein
the step of transmitting the information on said users comprises a step of transmitting the information representing the users found in the step of searching for said users to the client computers transmitting said first search information.

18. The information providing method according to claim 15, further comprising the steps of:
detecting the number of the stored users per said search item; and
transmitting information representing the number of the users per said search item and detected in the step of detecting the number of said users, to the client computers transmitting said second search information.

19. The information providing method according to claim 15, further comprising the steps of:
receiving determination information for determining, from the client computers transmitting said second search information, whether to transmit the information on said found users to the client computers transmitting said first search information, and storing the determination information per said user; and
determining whether to transmit the information on said users to the client computers transmitting said first search information based on said determination information.

20. The information providing method according to claim 15, further comprising a step of calculating charged amounts of money to be collected from the users transmitting said first search information.
